(19) United States
(12) Patent Application Publication
(10) Pub. No.: US 2013/0273371 A1
(43) Pub. Date: Oct. 17, 2013

(54) Process for Producing Monodisperse Polystyrene Micro-Particles

(71) Applicants: Pacita I. Tiemsin, Newport News, VA (US); Donald M. Oglesby, Hertford, NC (US); Jacqueline L. Schryer, Poquoson, VA (US)

(72) Inventors: Pacita I. Tiemsin, Newport News, VA (US); Donald M. Oglesby, Hertford, NC (US); Jacqueline L. Schryer, Poquoson, VA (US)

(73) Assignee: U.S.A. as represented by the Administrator of the National Aeronautics and Space Administration, Washington, DC (US)

(21) Appl. No.: 13/443,940

(22) Filed: Apr. 11, 2012

(51) Int. Cl. C08F 12/08; B32B 5/16; C08F 2/16

(52) U.S. Cl. 428/402; 526/222

(57) ABSTRACT

A process for producing highly monodisperse polystyrene particles includes steps of mixing water and styrene in a reactor, optionally adding an electrolyte to the mixture, purging the mixture of oxygen, adding a polymerization initiator while agitating and heating the mixture, and maintaining agitation and heating for a time sufficient to achieve a desired yield of monodisperse polystyrene particles having a particle size from 0.25 microns to 2.5 microns and a statistical quality factor greater than 10.

### STATEMENT REGARDING FEDERALLY SPONSORED RESEARCH OR DEVELOPMENT

The invention described herein was made in part by employees of the United States Government and may be manufactured and used by or for the Government of the United States of America for governmental purposes without the payment of any royalties thereon or therefor.

### FIELD OF THE INVENTION

This invention relates to monodisperse polystyrene micro-particles, and more particularly to processes for producing polystyrene particles wherein substantially all the particles have a narrow size distribution surrounding a desired size within the range of 0.5 microns to 2.5 microns, and to the resulting particles.

### BACKGROUND OF THE INVENTION

Micro-particles are spherical particles having a diameter from about 0.5 microns to about 10 microns that are fabricated from solids such as polymers, silica, or other material. Such micro-particles are useful in a variety of applications, including measurement of flow in aerodynamic research. Such micro-particles must be sufficiently large to avoid influences that result in Brownian motion, yet small enough to faithfully follow airstreams that are being measured. The actual size needed is a function of the wind tunnel application and is specified by wind tunnel researchers. The emphasis on the production of micro-particles from solid materials has arisen from the need for selectivity in particle diameter with minimum variance, a quality that is difficult to achieve using known techniques, such as kerosene smoke generators.

Another application for monodisperse micro-particles involves their use in evaluating the effectiveness of newly developed fabrics that are intended to be resistant to chemical and/or biological weapons. Such monodisperse micro-particles also have applications in the commercial chemical industry as paint pigments and as catalyst supports.

Micro-particles are useful in aerodynamic research for visualization of flow around models inside of wind tunnels. Flow visualization techniques can be applied to subsonic, transonic, and supersonic flow velocities. For subsonic applications, researchers use micro-particles for measurement of air stream velocity around a body being tested. A solution containing micro-particles is sprayed into the wind tunnel upstream of the model and velocity profiles can be determined using techniques such as laser Doppler velocimetry (LDV) and particle image velocimetry (PTV). For supersonic applications, the micro-particles are sprayed into the air flow and the measurement of the shock angle is used to measure the velocity of the air flow. This technique replaces flow probes and Schlieren interferometers.

Monodisperse polystyrene micro-particles may be used in velocimetry techniques conducted at temperatures below the melting point of polystyrene. At higher temperatures, polystyrene melts and is unsuitable for flow measurement. Instead, lightweight hollow particles may be produced by cladding silica onto polystyrene spheres and subsequently dissolving the polystyrene cores in the final step of production.

### SUMMARY OF THE INVENTION

An objective of this invention is to provide processes for making monodisperse polystyrene micro-particles meeting research specifications for uniformity in diameter and shape.

In certain embodiments, the invention provides a process for polymerizing monodisperse polystyrene particles by preparing a mixture of water and styrene in a reactor vessel, optionally adding an electrolyte to the mixture, purging the mixture of oxygen, adding a polymerization initiator to the mixture while agitating and heating the mixture in the reactor vessel, and maintaining agitation and heating for a time sufficient to achieve a desired yield of monodisperse polystyrene particles.

In accordance with certain embodiments, polystyrene particles having a desired particle size in the range from 0.5 microns to 2.5 microns and a statistical quality factor (the number mean particle diameter divided by the standard deviation of the particle diameters) greater than 10 are provided.

### DETAILED DESCRIPTION OF THE INVENTION

In accordance with certain embodiments of the invention, batch processes are provided for preparing monodisperse polystyrene micro-particles.

The term “monodisperse” as used herein refers to a collection of particles that have substantially the same size. Monodisperse particles are desirable in aerodynamic research to provide consistent optical reflection and refraction properties, and consistent motion in air streams. Desirably, the particles produced in accordance with the processes of this invention have a sufficiently small standard deviation such that the statistical quality factor (defined as the number mean particle diameter divided by the standard deviation of the diameters) is greater than 10.

The batch processes for polymerizing monodisperse polystyrene particles in accordance with the invention generally involve steps of preparing a mixture of water and styrene in a reaction vessel, optionally adding an electrolyte to the mixture, adding a polymerization initiator to the mixture while agitating and heating the mixture in the reactor vessel, and maintaining agitation and heating for a time sufficient to achieve a desired yield of polystyrene particles having a desired monodispersity and particle size.

The step of preparing a mixture of water, styrene, and optional electrolyte, can be performed in a reactor vessel, or in a container or vessel that does not function as a reactor, and subsequently introducing the mixture into a reactor vessel prior to addition of the initiator. However, in order to achieve excellent monodispersity, it is believed necessary to purge the mixture of oxygen while the mixture is in the reactor vessel, and to maintain oxygen purging during the polymerization process.

Desirably, water is added first, styrene is added to the water, and thereafter, an electrolyte may optionally be added.

Contrary to conventional emulsion polymerization processes, it has been discovered that surfactants are unnecessary, and may be undesirable. Accordingly, in certain embodiments of the invention the process involves preparation of a mixture consisting of or consisting essentially of water, styrene and an optional electrolyte; followed by the purging step, the addition of an initiator, and the steps of maintaining agitation and heating for a time sufficient to achieve a desired yield of monodisperse micro-particles.

Generally, it has been discovered that there is approximately a linear relationship between mean particle size and the concentration of electrolyte added to the mixture. In the case of batches in which 200 grams of styrene are added to 2,000 ml water, and polymerization is initiated by addition of potassium persulfate in an amount of 1.61 grams, particles having a mean diameter of 0.5 microns were produced in the absence of an electrolyte, particles having a mean diameter of 1 micron were produced by the addition of 0.11 grams of magnesium sulfate to the mixture, particles having a mean diameter of 1.5 microns were produced when 0.187 grams of magnesium sulfate were added to the mixture, and particles having a mean diameter of 2 microns were produced when 0.22 grams of magnesium sulfate were added to the mixture, all other reaction conditions being the same. For these examples, the correlation between magnesium sulfate concentration and particle size was found to approximately follow the equation Y=0.4282X+0.228, wherein Y is the mean particle size in microns, and X is the magnesium sulfate concentration in millimoles per liter.

Prior to adding the polymerization initiator to the mixture in the reactor vessel, the mixture of water, styrene and optional electrolyte is purged of oxygen. This may be accomplished by sparging or bubbling nitrogen, argon, or other suitably inert gas through the mixture and the reactor if desired, an oxygen sensor may be employed to monitor oxygen concentration in the head space (the volume above the mixture) of the reactor vessel to determine when oxygen concentration is sufficiently low to introduce the polymerization initiator.

Before adding the polymerization initiator, it is desirable to agitate and heat the mixture of water, styrene and optional electrolyte to desired reaction conditions. Generally, the degree of agitation that is employed is sufficient to maintain a dispersion or suspension in which styrene droplets are dispersed in an aqueous phase (water and optional electrolyte). Agitation is also maintained throughout the polymerization process to prevent growing polystyrene particles from agglomerating.

A suitable reaction temperature, to which the mixture is heated prior to addition of the polymerization initiator, is from about 65 degrees C. to about 75 degrees C., with a specific target temperature being about 70 degrees C.

When suitable oxygen purge, agitation and temperature stabilization has been achieved, the polymerization initiator is introduced into the reactor. This should be accomplished without introducing oxygen into the vessel, and while maintaining an inert gas purge.

A suitable level of agitation is maintained and temperatures are maintained within a desired range for a time sufficient to achieve a desired yield of polystyrene particles, which will have a relatively narrow particle size distribution (i.e., monodisperse particles). For the batch sizes and conditions described herein, a suitable period of time needed to achieve a complete reaction is about 22 hours.

Polymerization initiators other than the preferred potassium persulfate initiator may be employed, including various other persulfate and/or peroxide initiators, such as benzoyl peroxide.

Lightweight, hollow particles can be produced by cladding silica onto the polystyrene spheres produced in accordance with this invention, and subsequently dissolving the polystyrene cores. Thus, it is possible to use the monodisperse polystyrene micro-particles of this invention to produce monodisperse hollow silica spheres.

The techniques of this invention may also be employed for producing fluorescent monodisperse polystyrene micro-particles to provide fluorescently-labeled polystyrene microspheres that can be used, for example, for testing the integrity of chemical and/or biological resistant fabrics, such as by detection of fabric-penetrating particles with a fluorescent lamp.

A more detailed understanding of the invention can be had by consideration of the following examples.

Apparatus consisting of a 3 liter Pyrex reaction kettle having temperature controlled by a heating mantle and a cold finger condenser circulating tap water was used in the following examples. Temperature was controlled using a mercury thermoregulator which regulates heating and/or cooling as needed. The condenser returns any vaporized reactants to the reaction vessel. A stirring paddle insures sufficient agitation of the reactants.

The following procedure describes the production of polystyrene micro-particles having diameters in the range of 0.5 to 2.0 microns:

1. Select a formulation from Table 1 for a desired particle size.

2. Charge the reactor in the following order: Water, Styrene Magnesium Sulfate electrolyte solution.

3. Bubble nitrogen gas through the above mixture for 40 minutes in order to purge all oxygen from the reactor (approximately 0.5 liters/min. flow rate) using a gas dispersion tube (Pyrex, ASTM 170-220 or equivalent). Remove the tube from the reactor after 40 minutes and place a nitrogen line onto a gas inlet adapter atop the condenser, and maintain the nitrogen purge throughout the entire run.

4. Start the agitator (150 RPM) and begin heating to 70 degrees C.

5. When the temperature stabilizes at 70 degrees C., as evidenced by several cycles of the temperature controller, add potassium persulfate solution to the reactor via a pipet, insuring that the pipet tip is several inches below the liquid surface. This places the initiator well beneath the styrene layer on top and into the reaction zone in the water layer where the polymerization takes place. Run for 22 hours (beginning with addition of potassium persulfate).

6. At the end of the 22 hour period unplug the temperature controller and stop agitation. After cooling for a few minutes, remove any sticky, rubbery material which may form a separate layer on the top with paper towels. Filter through 100 mesh cheese cloth into a clean storage container. Filtration removes any coagulum or sticky substance from the particles. Styrene may polymerize on the stirring blade. The polystyrene adheres tenaciously to the blade, but can be removed by soaking in xylene overnight.

7. (OPTIONAL) lithe particles are to be stored longer than several months, it is advisable to place the sealed container of particles into a 65-70 degrees C. oven for 24 hours. This will minimize any chance for biological growth.

TABLE 1
Polystyrene Micro-particle Formulations for Specific Particle Sizes

| | | Particle Diameter (micron) | | | |
|---|---|---|---|---|---|
| Ingredient | Units | 0.5 | 1.0 | 1.5 | 2.0 |
| Water | ml | 2000 | 2000 | 2000 | 2000 |
| Styrene | g | 200 | 200 | 200 | 200 |
| Magnesium Sulfate | g | 0 | 0.110 | 0.187 | 0.220 |
| Potassium Persulfate | g | 1.61 | 1.61 | 1.61 | 1.61 |

The invention has been described with reference to the preferred embodiments. Of course, modifications and alterations will occur to others upon reading and understanding the preceding description. It is intended that the invention be construed as including all such modifications and alterations insofar as they come within the scope of the appended claims.

What is claimed is:

1. A process for polymerizing styrene to produce monodisperse polystyrene micro-particles consisting essentially of:
preparing a mixture of water, styrene and an electrolyte in a reactor vessel;
purging the mixture of oxygen;
adding a polymerization initiator to the mixture while agitating and heating the mixture in the reactor vessel, wherein the mixture is maintained at a temperature of from 65 degrees C. to 75 degrees C. during polymerization;
maintaining agitation and heating for a time sufficient to achieve a desired yield of monodisperse polystyrene micro-particles comprising a particle size from 0.25 microns to 2.5 microns.

2. The process of claim 1, wherein the polymerization initiator is potassium persulfate.

3. The process of claim 2, wherein the electrolyte is magnesium sulfate.

4. The process of claim 3, the monodisperse polystyrene micro-particles further comprising a statistical quality factor greater than 10.

5. A process for polymerizing styrene to produce monodisperse polystyrene micro-particles, comprising:
preparing a mixture of water, styrene and an optional electrolyte in a reactor vessel;
purging the mixture of oxygen;
adding a polymerization initiator to the mixture while agitating and heating the mixture in the reactor vessel; and
maintaining agitation and heating for a time sufficient to achieve a desired yield of monodisperse polystyrene micro-particles.

6. The process of claim 5, wherein the electrolyte is magnesium sulfate.

7. The process of claim 6, wherein the polymerization initiator is potassium persulfate.

8. The process of claim 7, wherein the mixture is maintained at a temperature of from 65 degrees C. to 75 degrees C. during polymerization.

9. The process of claim 8, the monodisperse polystyrene micro-particles comprising a particle size from 0.25 microns to 2.5 microns.

10. The process of claim 8, the monodisperse polystyrene micro-particles comprising a particle size from about 0.25 microns to about 2.5 microns.

11. The process of claim 8, the monodisperse polystyrene micro-particles further comprising a statistical quality factor greater than 10.

12. Monodisperse polystyrene micro-particles having a particle size from 0.25 microns to 2.5 microns and a statistical quality factor greater than 10.
